(19) United States
(12) Patent Application Publication
(10) Pub. No.: US 2009/0214392 A1
(43) Pub. Date: Aug. 27, 2009

(54) Nano-fluidic Trapping Device for Surface-Enhanced Raman Spectroscopy

(75) Inventors: Jun Kameoka, College Station, TX (US); Gerard L. Cote, College Station, TX (US); Hope T. Beier, College Station, TX (US); I-Hsien Chou, Diamond Bar, CA (US); Melodie Benford, College Station, TX (US); Miao Wang, College Station, TX (US); Nan Jing, College Station, TX (US)

Correspondence Address: Tod T. Tumey, P.O. BOX 22188, HOUSTON, TX, 77227-2188, US

(73) Assignee: THE TEXAS A&M UNIVERSITY SYSTEM, College Station, TX (US)

(21) Appl. No.: 12/038,700

(22) Filed: Feb. 27, 2008

(51) Int. Cl. B01L 3/00; B29C 65/00

(52) U.S. Cl. 422/102; 156/60

(57) ABSTRACT

A nano-fluidic trapping device and method of fabrication are disclosed. In one embodiment, a nano-fluidic trapping device for assembling a SERS-active cluster includes a substrate. The nano-fluidic trapping device further includes a SERS-active cluster compartment. The SERS-active cluster is formed in the SERS-active cluster compartment. In addition, the nano-fluidic trapping device includes a reservoir. The reservoir allows introduction of target molecules into the nano-fluidic trapping device. Moreover, the nano-fluidic trapping device includes a microchannel. The microchannel allows the target molecules to be introduced to the SERS-active cluster compartment from the reservoir. The nano-fluidic trapping device also includes a nanochannel. The SERS-active cluster compartment, the reservoir, the microchannel, and the nanochannel are disposed within the substrate.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of Surface Enhanced Raman Spectroscopy and more specifically to a nano-fluidic trapping device for Surface Enhanced Raman Spectroscopy.

2. Background of the Invention

Surface Enhanced Raman Spectroscopy (SERS) has been used for enhancing the Raman cross section of a molecule. In SERS, target molecules are conventionally adsorbed onto SERS-active structures. SERS-active structures typically include roughened electrodes or nanoparticles such as gold or silver nanoparticles. The SERS-active structures may provide improved electromagnetic and chemical enhancement at SERS-active sites when exposed to an excitation laser source. Drawbacks to SERS include the non-uniform distribution of such SERS-active sites providing challenges in controlling and obtaining consistent enhancement, which may result in unreliable and non-reproducible results. Further drawbacks include that target molecules are typically randomly adsorbed on the nanoparticle clusters, which results in a low probability that target molecules are confined in a SERS-active site.

Methods have been developed to overcome these drawbacks of the conventional SERS application. For instance, metal nanoparticle-array plates with periodically aligned nanoparticles on the detection site have been developed as SERS-active substrates. In addition, a nanoparticle-film with temperature-controllable inter-particle spacing has been developed as a tunable SERS substrate to generate optimal SERS signal intensity. Other substrates such as metal-film-over-nanospheres (MFON) and nanowell surfaces in micro-fluidic biochips have been used for SERS. Further developments include that metal nanoshells and nanorods have been used as SERS-active substrates. Drawbacks to these developments include inefficient lengths of time for the molecules to adsorb on the SERS-active site. Additional drawbacks include non-uniform distribution of molecular adsorption on the SERS-active site at low sample concentrations.

Consequently, there is a need for improving the robustness, repeatability, and sensitivity of SERS.

### BRIEF SUMMARY OF SOME OF THE PREFERRED EMBODIMENTS

These and other needs in the art are addressed in one embodiment by a nano-fluidic trapping device for assembling a SERS-active cluster. The nano-fluidic trapping device includes a substrate. The nano-fluidic trapping device further includes a SERS-active cluster compartment. The SERS-active cluster is formed in the SERS-active cluster compartment. In addition, the nano-fluidic trapping device includes a reservoir. The reservoir allows introduction of target molecules into the nano-fluidic trapping device. Moreover, the nano-fluidic trapping device includes a microchannel. The microchannel allows the target molecules to be introduced to the SERS-active cluster compartment from the reservoir. The nano-fluidic trapping device also includes a nanochannel. The SERS-active cluster compartment, the reservoir, the microchannel, and the nanochannel are disposed within the substrate.

In another embodiment, these and other needs in the art are addressed by a method of fabricating a nano-fluidic trapping device for forming a SERS-active cluster. The method includes providing a wafer. The method also includes defining a microchannel, a nanochannel, and a SERS-active cluster compartment in the wafer to provide a defined wafer. In addition, the method includes bonding the defined wafer with another wafer to form the nano-fluidic trapping device.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a side cross sectional view of a nano-fluidic trapping device with a SERS-active cluster compartment having a sloped side;

FIG. 2 illustrates a top cross sectional view of the nano-fluidic trapping device of FIG. 1;

FIG. 3 illustrates an enlarged view of section A of FIG. 1;

FIG. 4 illustrates the nano-fluidic trapping device of FIG. 3 with a SERS-active cluster;

FIG. 5 illustrates a top cross sectional view of a nano-fluidic trapping device with a SERS-active cluster compartment having a reduced diameter step configuration;

FIG. 6 illustrates a side cross sectional view of the nano-fluidic trapping device of FIG. 5;

FIG. 7 illustrates the nano-fluidic trapping device of FIG. 5 with a SERS-active cluster;

FIG. 8 illustrates the nano-fluidic trapping device of FIG. 6 with a SERS-active cluster;

FIG. 9 illustrates a top cross sectional view of a nano-fluidic trapping device with a SERS-active cluster compartment having a triangular configuration;

FIG. 10 illustrates a side cross sectional view of the nano-fluidic trapping device of FIG. 9;

FIG. 11 illustrates a top cross sectional view of a nano-fluidic trapping device with a SERS-active cluster compartment having a pillar configuration;

FIG. 12 illustrates a side cross sectional view of the nano-fluidic trapping device of FIG. 11;

FIG. 13 illustrates the nano-fluidic trapping device of FIG. 11 with target molecules;

FIG. 14 illustrates the nano-fluidic trapping device of FIG. 11 with a SERS-active cluster;

FIG. 15 illustrates a fluorescent image of PS particles trapped at the entrance of the nanochannel;

FIG. 16 illustrates an optical micrograph of a top view of the empty nano-fluidic trapping device;

FIG. 17 illustrates Raman signals of adenine molecules;

FIG. 18 illustrates an enhanced Raman signal from a 10 μm adenine solution monitored over 30 minutes;

FIG. 19 illustrates SERS signal intensity of adenine changing over time;

FIG. 20 illustrates SERS signal intensity changes corresponding with a conformational change of beta-amyloid as it refolds from an alpha-helical to beta-sheet form; and

FIG. 21 illustrates the ability to distinguish SERS signal intensity differences of complex media with different components such as beta-amyloid, albumin, and insulin.

### DETAILED DESCRIPTION OF THE PREFERRED EMBODIMENTS

In an embodiment, a nano-fluidic trapping device includes a SERS-active cluster compartment, microchannels, a nanochannel, and reservoirs. It has been found that the nano-fluidic trapping device improves the robustness, repeatability, and sensitivity of Surface Enhanced Raman Spectroscopy (SERS). Without limitation, metal nanoparticles and target molecules in aqueous solution may be reproducibly trapped by force (e.g., capillary force) to form SERS-active clusters. It has further been found that the nano-fluidic trapping device provides improved sensitivity by providing an increased local density of nano-particle/target molecules in the SERS-active cluster compartment. In addition, the nano-fluidic trapping device may provide reproducibility because the SERS-active clusters may be consistently formed in the SERS-active cluster compartment.

The SERS-active cluster compartment may be disposed proximate or within the nanochannel. The SERS-active cluster compartment may have any configuration suitable for increasing the local density of target molecules. For instance, without limitation, examples of SERS-active cluster compartment configurations include a sloped configuration, a reduced diameter step configuration, a triangular configuration, and a pillar configuration. It is to be understood that the structure or shape of the SERS-active cluster may be controlled by the design of the SERS-active cluster compartment.

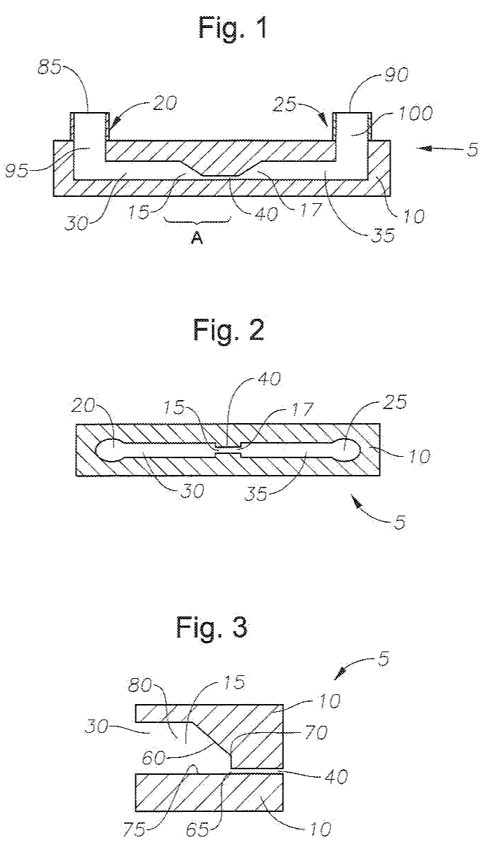

FIG. 1 illustrates a side cross sectional view of nano-fluidic trapping device 5 having substrate 10, SERS-active cluster compartment 15, reservoir 20, reservoir 25, microchannel 30, microchannel 35, and nanochannel 40. Substrate 10 may be any material suitable for use in SERS. In an embodiment, substrate 10 is an optically clear and substantially flat material. Without limitation, examples of suitable substrates 10 include fused silica, borosilicate, plastic, or silicon. In an embodiment, substrate 10 is fused silica. In some embodiments, substrate 10 is hydrophilic. Substrate 10 may have any configuration and dimensions suitable for use in SERS. FIG. 2 illustrates a top cross sectional view of nano-fluidic trapping device 5 showing SERS-active cluster compartment 15, reservoir 20, reservoir 25, microchannel 30, microchannel 35, and nanochannel 40 disposed within substrate 10.

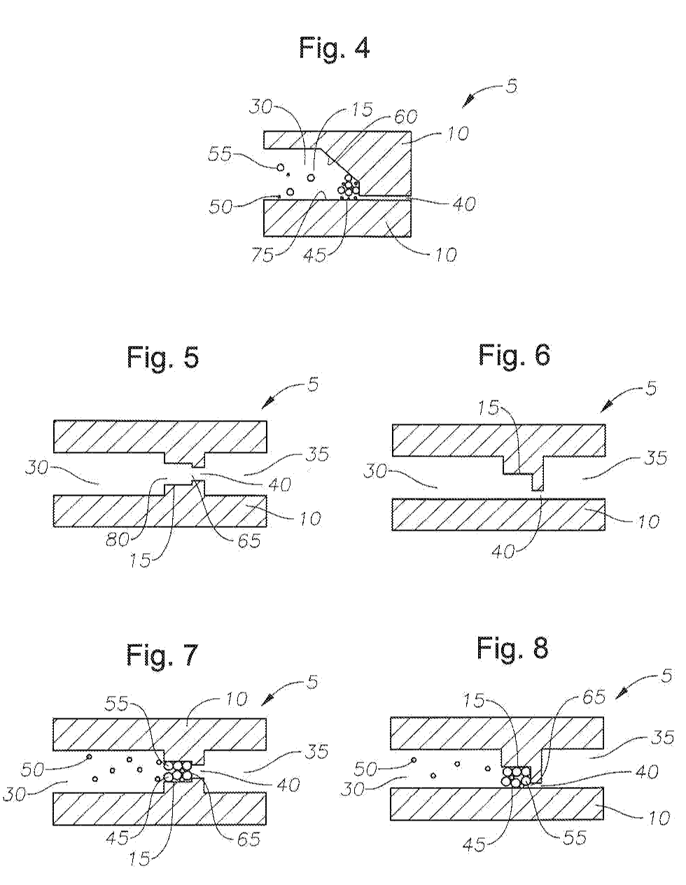

As illustrated in FIG. 1, SERS-active cluster compartment 15 has a sloped configuration and is disposed between microchannel 30 and nanochannel 40, and SERS-active cluster compartment 17 is disposed between microchannel 35 and nanochannel 40. FIG. 3 illustrates an enlarged view of Section A of FIG. 1. It is to be understood that the enlarged view of FIG. 3 is provided for illustration purposes only. As shown in FIG. 3, SERS-active cluster compartment 15 has sloped side 60 that slopes at an angle and extends from microchannel 30 toward nanochannel 40, reducing the diameter (and thereby the volume) of SERS-active cluster compartment 15 as sloped side 60 approaches nanochannel 40. Sloped side 60 may have any suitable angle to microchannel 30 to provide a desired volume of SERS-active cluster compartment 15. In an embodiment as illustrated in FIG. 3, sloped side 60 has an angle at which sloped side 60 terminates into substrate 10 at a position 70 above SERS-active cluster compartment exit 65. In such an embodiment, SERS-active cluster compartment 15 extends from position 70 at a right angle to SERS-active cluster compartment exit 65. In alternative embodiments (not illustrated), sloped side 60 may have an angle to microchannel 30 that allows sloped side 60 to terminate into SERS-active cluster compartment exit 65. In other alternative embodiments (not illustrated), SERS-active cluster compartment 15 extends from position 70 at an angle other than a right angle to SERS-active cluster compartment exit 65 to provide a further sloped side. As further illustrated in FIG. 3, SERS-active cluster compartment 15 has compartment side 75 opposing sloped side 60. Compartment side 75 is substantially flat and extends from microchannel 30 to nanochannel 40. In an embodiment as illustrated in FIG. 3, entrance 80 to SERS-active cluster compartment 15 from microchannel 30 may have about the same diameter as microchannel 30. In alternative embodiments (not illustrated), entrance 80 has a diameter less than the diameter of microchannel 30. FIG. 4 illustrates an embodiment of FIG. 3 showing SERS-active cluster 45 disposed in SERS-active cluster compartment 15. Sloped side 60 facilitates disposition of SERS-active cluster 45 proximate to SERS-active cluster compartment exit 65. In an embodiment, target molecules 50 and metal nanoparticles 55 may flow from microchannel 30 to SERS-active cluster compartment 15 into SERS-active cluster 45. It is to be understood that the described embodiments of FIG. 3 are not limited to SERS-active cluster compartment 15 and microchannel 30 but also apply to SERS-active cluster compartment 17 and microchannel 35. In an embodiment as illustrated in FIG. 3, SERS-active cluster compartment 15 has the same configuration and dimensions as SERS-active cluster compartment 17. In alternative embodiments (not illustrated), SERS-active cluster compartment 15 has a different configuration and/or dimensions from SERS-active cluster compartment 17. In an embodiment, SERS-active cluster compartment exit 65 may have any diameter suitable for preventing flow of target molecules 50 and/or metal nanoparticles 55 from SERS-active cluster compartment 15 into nanochannel 40. In some embodiments, SERS-active cluster compartment exit 65 has a diameter suitable for preventing SERS-active cluster 45 from exiting SERS-active cluster compartment 15. In an embodiment as illustrated in FIG. 2, SERS-active cluster compartment exit 65 has about the same diameter as the diameter of nanochannel 40. In alternative embodiments (not illustrated), SERS-active cluster compartment exit 65 has a different diameter than the diameter of nanochannel 40. In some alternative embodiments (not illustrated), nano-fluidic trapping device 5 has SERS-active cluster compartment 15 but not SERS-active cluster compartment 17 with the opposing side of nanochannel 40 opening into microchannel 35 instead of SERS-active cluster compartment 17.

As illustrated in FIG. 1, nano-fluidic trapping device 5 includes reservoirs 20, 25. Reservoir 20 has reservoir opening 85, and reservoir 25 has reservoir opening 90, which allow target molecules 50 and metal nanoparticles 55 to be introduced to nano-fluidic trapping device 5. Reservoir openings 85, 90 may have any diameter suitable for introduction of target molecules 50 and metal nanoparticles 55 into nano-fluidic trapping device 5. Reservoir 20 has reservoir channel 95, and reservoir 25 has reservoir channel 100. Reservoir channels 95, 100 allow target molecules 50 and metal nanoparticles 55 to flow from reservoir openings 85, 90 to the respective microchannel 30, 35. Reservoirs 20, 25 may have any configuration suitable for allowing the introduction of target molecules 50 and metal nanoparticles 55 into nano-fluidic trapping device 5. In alternative embodiments (not illustrated), inserts may be disposed in reservoirs 20, 25. The inserts may be any material suitable for facilitating the flow of target molecules 50 and metal nanoparticles 55 into nano-fluidic trapping device 5. For instance, the inserts may be composed of plastic, metal, or glass.

Nano-fluidic trapping device 5 also includes microchannels 30, 35 as illustrated in FIG. 2. Microchannels 30, 35 may have any dimensions suitable for allowing target molecules 50 and metal nanoparticles 55 to flow to SERS-active cluster compartments 15, 17. In an embodiment, microchannels 30, 35 have a width from about 15 μm to about 150 μm; a depth from about 2 μm to about 6 μm; and/or a length from about 1 cm to about 2.5 cm.

As illustrated in FIG. 2, nano-fluidic trapping device 5 also includes nanochannel 40. Nanochannel 40 may have any diameter or other dimensions suitable for allowing forced flow of an aqueous fluid from microchannel 30 to microchannel 35. In some embodiments, nanochannel 40 may have a diameter less than the diameter of metal nanoparticles 55. Without being limited by theory, nanochannel 40 has a diameter less than the diameter of metal nanoparticles 55 to prevent the flow of metal nanoparticles 55 out of SERS-active cluster compartment 15 to nanochannel 40. In an embodiment, nanochannel 40 has a depth from about 40 nanometers (nm) to about 50 nm and/or a width from about 2 μm to about 25 μm.

FIG. 5 illustrates a top cross sectional view of an embodiment of nano-fluidic trapping device 5 in which SERS-active cluster compartment 15 has a reduced diameter step configuration. It is to be understood that FIG. 5 shows only a portion of nano-fluidic trapping device 5 with reservoirs 20, 25 not shown for illustration purposes only. FIG. 6 illustrates a side cross sectional view of the embodiment of nano-fluidic trapping device 5 illustrated in FIG. 5. As shown in FIG. 5, SERS-active cluster compartment 15 has entrance 80 with a diameter less than the diameter of microchannel 30 but sufficiently large to allow the flow of target molecules 50 and metal nanoparticles 55 into SERS-active cluster compartment 15. In an embodiment as illustrated in FIG. 5, SERS-active cluster compartment 15 has a substantially uniform diameter from entrance 80 to SERS-active cluster compartment exit 65. In an embodiment, SERS-active cluster compartment 15 has about the same diameter as entrance 80. SERS-active cluster compartment exit 65 has a diameter less than the diameter of SERS-active cluster compartment 15. In an embodiment as illustrated in FIG. 5, SERS-active cluster compartment exit 65 has a diameter about the same as the diameter of nanochannel 40. In alternative embodiments (not illustrated), SERS-active cluster compartment exit 65 has a diameter different that the diameter of nanochannel 40. FIGS. 7 and 8 illustrate embodiments of nano-fluidic trapping device 5 as illustrated in FIGS. 5 and 6, respectively, with SERS-active cluster 45 disposed in SERS-active cluster compartment 15. The reduced diameter step configuration of SERS-active cluster compartment 15 facilitates disposition of SERS-active cluster 45 proximate to SERS-active cluster compartment exit 65. In an embodiment, target molecules 50 and metal nanoparticles 55 may be transported from microchannel 30 to SERS-active cluster compartment 15 and into SERS-active cluster 45.

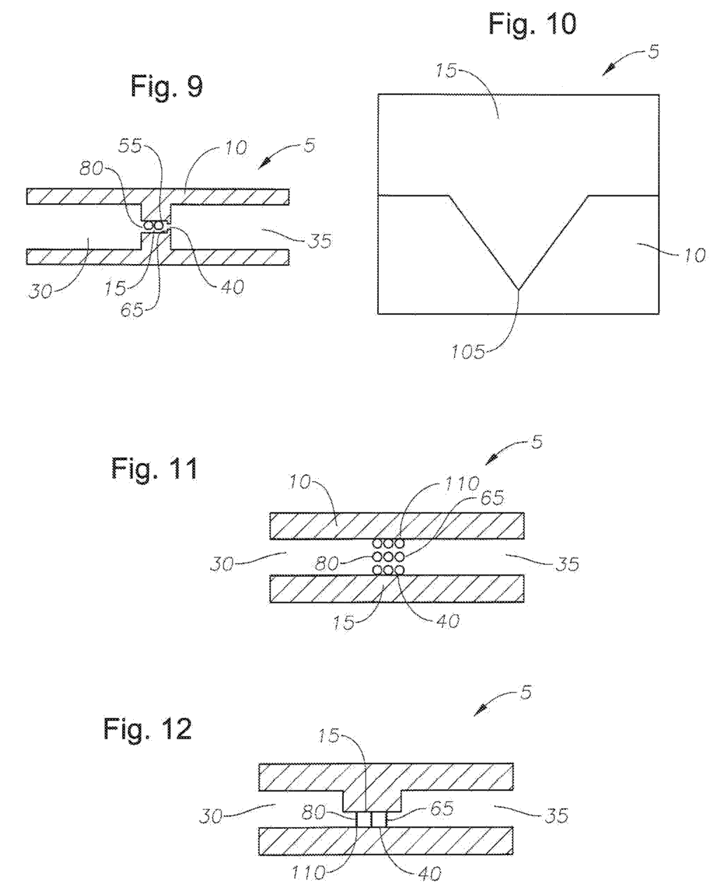

FIG. 9 illustrates a top cross sectional view of an embodiment of nano-fluidic trapping device 5 in which SERS-active cluster compartment 15 has a triangular configuration. It is to be understood that FIG. 9 shows only a portion of nano-fluidic trapping device 5 with reservoirs 20, not shown for illustration purposes only. FIG. 10 illustrates a side cross sectional view of the embodiment of nano-fluidic trapping device 5 illustrated in FIG. 9. As shown in FIG. 9, SERS-active cluster compartment 15 has entrance 80 with a diameter less than the diameter of microchannel 30 but sufficiently large to allow the flow of target molecules 50 and metal nanoparticles 55 into SERS-active cluster compartment 15. In some non-limiting embodiments of FIGS. 9 and 10, SERS-active cluster compartment 15 has a depth from about 40 nm to about 2,000 nm. In an embodiment as illustrated in FIGS. 9 and 10, SERS-active cluster compartment 15 has a triangular nanochannel configuration with the apex 105 of the triangular nanochannel configuration at the bottom of the channel. SERS-active cluster compartment exit 65 has a diameter less than the diameter of SERS-active cluster compartment 15. In an embodiment as illustrated in FIG. 9, SERS-active cluster compartment exit 65 has a diameter about the same as the diameter of nanochannel 40. In alternative embodiments (not illustrated), SERS-active cluster compartment exit 65 has a diameter different that the diameter of nanochannel 40. In the embodiments as illustrated in FIGS. 9 and 10, SERS-active cluster compartment 15 may be uncoated or coated with a coating. The coating may be any material suitable for use with SERS and for facilitating formation of SERS-active clusters 45. Without limitation, examples of suitable coatings include gold, silver, platinum, copper, aluminum, or combination thereof. The coating may be applied by any suitable method such as physical evaporation and sputtering.

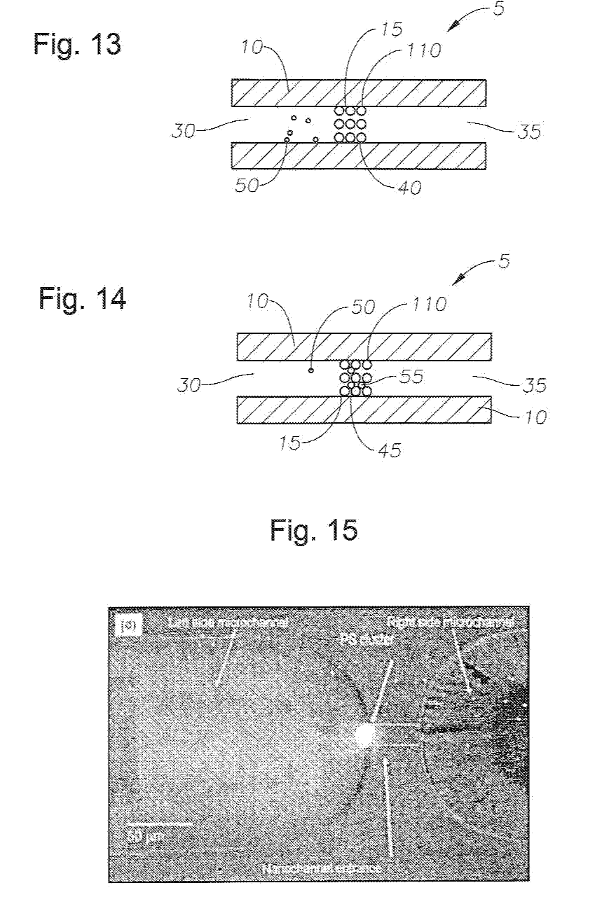

FIG. 11 illustrates a top cross sectional view of an embodiment of nano-fluidic trapping device 5 in which SERS-active cluster compartment 15 has a pillar configuration and is disposed in nanochannel 40. It is to be understood that FIG. 11 shows only a portion of nano-fluidic trapping device 5 with reservoirs 20, 25 not shown for illustration purposes only. FIG. 12 illustrates a side cross sectional view of the embodiment of nano-fluidic trapping device 5 illustrated in FIG. 11. As shown in FIG. 11, SERS-active cluster compartment 15 has a plurality of nanopillars 110. Nanopillars 110 are slender, vertical structures. Nanopillars 110 are composed of substrate 10 material. In some embodiments, nanopillars 110 are coated with a coating. The coating may be any material suitable for use with SERS and for facilitating formation of SERS-active clusters 45. Without limitation, examples of suitable coatings include gold, silver, platinum, copper, aluminum, or combination thereof. In an embodiment, the coating is gold, silver, or combination thereof. The coating may be applied by any suitable method such as physical evaporation or sputtering. In alternative embodiments, nanopillars 110 are not coated. In an embodiment, the spacing between nanopillars 110 may be less than the diameter of metal nanoparticle 55. As shown in FIG. 12, SERS-active cluster compartment 15 has entrance 80 with a diameter about the same as the diameter of nanochannel 40. In some embodiments of nano-fluidic trapping device 5 illustrated in FIGS. 11 and 12, nanochannel 40 has a sufficient diameter to allow target molecules 50 and/or metal nanoparticles 55 to flow to SERS-active cluster compartment 15. FIG. 13 illustrates an embodiment of nano-fluidic trapping device 5 with nanopillars 110 coated with a coating (not illustrated). In such an embodiment, target molecules 50 are detected without use of metal nanoparticles 55. FIG. 14 illustrates an embodiment of nano-fluidic trapping device 5 with use of metal nanoparticles 55 to form SERS-active cluster 45 in SERS-active cluster compartment 15. In the embodiment of nano-fluidic trapping device 5 illustrated in FIG. 14, nanopillars 110 may be coated with a coating or may not be coated.

In operation of the embodiments illustrated in FIGS. 1-14, target molecules 50 are suspended in an aqueous solution and introduced to nano-fluidic trapping device 5 via reservoir opening 85 of reservoir 20. Any aqueous solution suitable for use in SERS may be used. Target molecules 50 flow from reservoir 20 to microchannel 30. From microchannel 30, target molecules 50 flow to SERS-active cluster compartment 15 in which target molecules 50 are adsorbed on coatings and/or metal nanoparticles 55 to form SERS-active cluster 45. For instance, in an embodiment in which metal nanoparticles 55 are used, metal nanoparticles 55 are fed in aqueous solution to nano-fluidic trapping device 5 via reservoir opening 85 of reservoir 20. Metal nanoparticles 55 flow from reservoir 20 to microchannel 30. From microchannel 30, metal nanoparticles 55 flow to SERS-active cluster compartment 15 by which their flow is stopped by SERS-active cluster compartment exit 65 and/or nanopillars 110, depending on the configuration of which SERS-active cluster compartment 15 is comprised. In such an embodiment, target molecules 50 adsorb on metal nanoparticles 55 to form SERS-active cluster 45. The size of SERS-active cluster 45 may grow as more metal nanoparticles 55 are trapped in SERS-active cluster compartment 15 and more target molecules 50 are adsorbed on metal nanoparticles 55 in SERS-active cluster 45. In embodiments of nano-fluidic trapping device 5 illustrated in FIGS. 9-14 in which a coating but not metal nanoparticles 55 are used, target molecules 50 adsorb on the coating to form SERS-active cluster 45. In embodiments of nano-fluidic trapping device 5 illustrated in FIGS. 9-14 in which a coating and metal nanoparticles 55 are used, target molecules 50 adsorb on the coating and metal nanoparticles 55 to form SERS-active cluster 45. Target molecules 50 and metal nanoparticles 55 flow by force to SERS-active compartment 15 by any suitable method. Without limitation, examples of suitable methods include capillary force, electro-osmotic pump, centrifugal force, electromagnetic field, or combination thereof. Capillary force includes the flow between reservoirs 20, 25 due to un-equal pressures between reservoirs 20, 25. The electro-osmotic pump is disposed in nanochannel 40. The electro-osmotic pump may pump the target molecules 50 and metal nanoparticles 55 through nanochannel 40 to reservoir 25. Centrifugal force includes using a centrifuge to spin nano-fluidic trapping device 5. For instance, after target molecules 50 and metal nanoparticles 55 are disposed in nano-fluidic trapping device 5 through reservoir 20, nano-fluidic trapping device 5 may be placed on a centrifuge to use centrifugal force to speed up the flow and SERS-active cluster 45 formation. The electromagnetic field embodiment includes altering the magnetic field under nano-fluidic trapping device 5 by applying a voltage under nano-fluidic trapping device 5 to draw the flow of target molecules 50 and metal nanoparticles 55 through nano-fluidic trapping device 5. For instance, after target molecules 50 and metal nanoparticles 55 are introduced into nano-fluidic trapping device 5, an external electric field may be applied onto nano-fluidic trapping device 5 through two reservoirs by connecting an anode and a cathode to the solution in the reservoir, respectively. Without being limited by theory, after formation of SERS-active cluster 45 in SERS-active cluster compartment 15, target molecules 50 and metal nanoparticles 55 may continue to flow into SERS-active cluster compartment 15, which may increase the number of SERS-active sites and raise the SERS signal intensity. In an embodiment, metal nanoparticles 55 and target molecules 50 form SERS-active cluster 45 to provide spectral information to determine conformational changes within a molecule or molecules (i.e., the alpha-helical versus beta-sheet form of beta-amyloid). In some embodiments, metal nanoparticles 55 and target molecules 50 form SERS-active cluster 45 to provide a spectra of a target molecule 50 that may distinguish possibly confounding molecules in a complex media (i.e., distinguishing the beta-amyloid from albumin or insulin in cerebral spinal fluid). In some embodiments, the aggregation of metal nanoparticles 55 may be improved in terms of time and speed by the centrifuge and/or electrophoresis.

Target molecules 50 may include any molecule desired to be detected by SERS. For instance, target molecules 50 may be chemical or biological species such as proteins, nucleic acids, and the like. Metal nanoparticles 55 may be any nanoparticles suitable for adsorbing target molecules 50 and for detection of target molecules 50 by SERS. For instance, metal nanoparticles may include gold, silver, platinum, copper, aluminum, or combination thereof. In an embodiment, the metal nanoparticle comprises gold.

In an embodiment, nano-fluidic trapping device 5 is fabricated by providing a wafer. The wafer may have any configuration suitable for use with nano-fluidic trapping device 5. It is to be understood that the wafer forms substrate 10 and therefore is composed of the same material as substrate 10. The wafer is defined by lithography. Any method of lithography suitable for defining the wafer may be used. For instance, in an embodiment, the method of lithography includes photolithography or focused ion beam lithography. Defined refers to fabricating channel patterns in the wafer. The channel patterns may represent SERS-active cluster compartment 15; microchannels 30, 35; and nanochannel 40. In some embodiments, etching is used to facilitate defining the wafer. Any method of etching suitable for facilitating defining the wafer may be used. In an embodiment, the method of etching is wet etching or plasma etching. Any method of wet etching suitable for defining the wafer may be used. For instance, potassium hydroxide (KOH) etching or hydrofluoric acid (HF) etching may be used. In alternative embodiments, lithography or etching are used to define the wafer. In embodiments, inlet holes are formed in the defined wafer, which provide reservoirs 20, 25. Any method of forming the inlet holes in a wafer may be used. In an embodiment, sand blasting is used to form the inlet holes. In alternative embodiments, inlets are attached to the inlet holes. In some embodiments, a coating is applied to a desired portion of the defined wafer. The coating may be applied by any suitable method. In embodiments, the defined wafer with inlet holes is bonded to another wafer to form nano-fluidic trapping device 5. The wafers may be bonded by any suitable method. For instance, the wafers may be slightly heated and then contacted together to form the bond. It is to be understood that the method of defining the wafer is varied depending on the configuration of SERS-active cluster compartment 15 desired. For example, an embodiment of manufacturing nano-fluidic trapping device 5 in which SERS-active cluster compartment 15 includes nanopillars 110 may include placing a pattern of the desired nanopillars 110 on the wafer. Focused ion beam lithography is applied to the wafer via the pattern to form nanopillars 110. A desired form of etching may then be used to finalize defining nanopillars 110 of the wafer. In some embodiments, a coating may then be applied to the wafer to coat nanopillars 110. Nanopillars 110 may also be manufactured by hot embossing or molecular imprint lithography on the wafer surface.

In alternative embodiments (not illustrated), metal nanoparticles 55 and/or nanochannel 40 may be functionalized to provide specificity for binding of target molecules 50. Functionalization may facilitate reducing or eliminating non-specific binding of molecules. For instance, metal nanoparticles 55 may be coated with a substance or substances to promote specific binding of target molecules 50 and avoid non-specific binding (i.e., antigen-antibody).

To further illustrate various illustrative embodiments of the present invention, the following example is provided.

### Example

A nano-fluidic trapping device was fabricated on a 500 μm-thick, double-sided and polished borosilicate wafer using photolithography and etching methods. The nano-fluidic trapping device had a deep microchannel and a shallow nanochannel. The shallow nanochannel had a 40 nm depth, a 5 μm width, and a 40 μm length. The nanochannel was used for trapping nanoparticles with a diameter of 60 nm at the microchannel-nanochannel junction. Photolithography and focused ion beam methods were used to define the nanochannel. The deep microchannel had a 6 μm depth with a 150 μm width and was defined by photolithography and a wet HF etching process. After the wet HF etching process, inlet holes were made by a sand blaster through the substrate wafer, which was bonded to another flat borosilicate wafer to seal the trenches and create the fluidic channels. Two plastic reservoirs were attached on both inlet holes. Schematic diagrams of this nano-fluidic trapping device are shown in FIGS. 1 and 2.

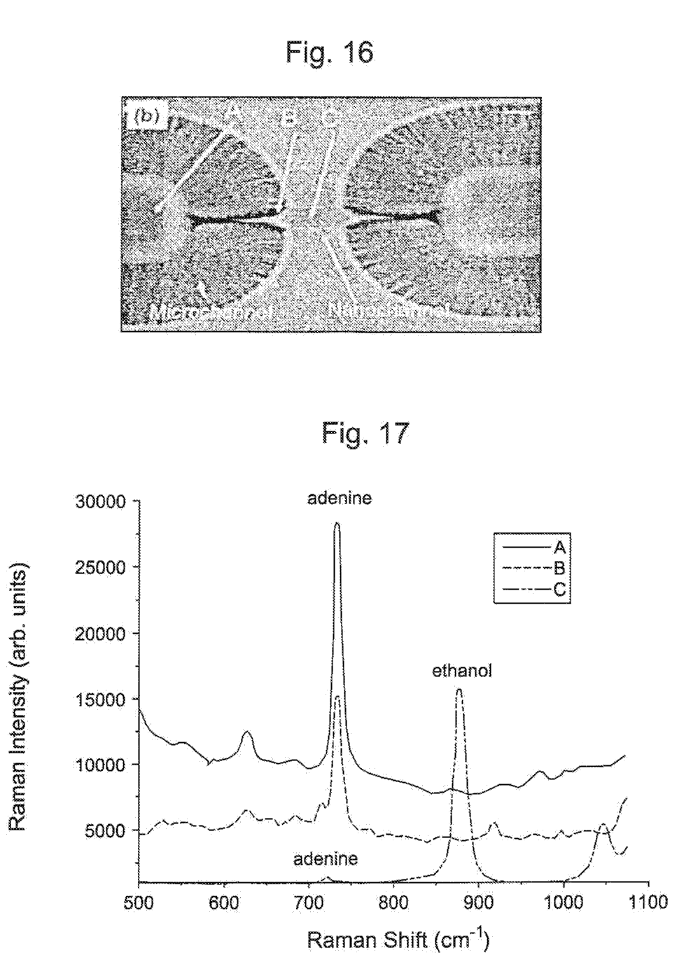

Immediately after a sample solution was dispensed in the microchannel, gold nanoparticles with target molecules were transported and trapped at the nanochannel entrance due to capillary force. To confirm the trapping capability of this nano-fluidic trapping device, fluorescent polystyrene (PS) nanoparticles in aqueous solution (commercially available from Spherotech Inc.) with a size ranging from 40-90 nm were introduced into the nano-fluidic trapping device. Since the diameter of the fluorescent nanoparticles was larger than the depth of the shallow nanochannel, they were trapped at the nanochannel entrance. The solution of PS beads was diluted to 5 mg/l using deionized (DI) water and then introduced into the nanochannel from the reservoir on the left side. Due to capillary force, the solution was transported into the nano-fluidic trapping device within a few seconds. The fluorescent image of PS particles trapped at the entrance of the nanochannel immediately after the dispensing of the solution is shown in FIG. 15. The PS particles emitted extremely high fluorescent signals around the entrance compared to other locations in the microchannel region. FIG. 16 shows an optical micrograph of the empty nano-fluidic trapping device from the top view. Area A was the microchannel with a depth of 6 μm and a width of 150 μm. The step boundary was shown as Area B. Area C was the nanochannel with a depth of 40 nm and a width of 5 μm. To investigate channel clogging by the aggregated nanoparticles, 12 μM Rhodamine B in DI water was dispensed into the channel after the PS nanoparticle cluster had been formed at the entrance of the nanochannel. The fluorescent signal from Rhodamine B was observed at both the left and right side of the microchannels. This concluded that there were tiny interstices at the entrance of the nanochannel after the formation of particle clusters, and a weak capillary flow may be used to transport Rhodamin B molecules through the cluster and nanochannel site.

To assess this nano-fluidic trapping device, the enhancement factor of these nanoparticle clusters were estimated and compared to other SERS techniques using adenine as an analyte. The excitation laser was focused at the nanochannel entrance to obtain the surface enhanced Raman spectra of adenine molecules. SERS detection was accomplished using a RENISHAW SYSTEM 1000 Raman Spectrometer (commercially available from Renishaw) coupled to a LEICA DMLM microscope (commercially available from Leica Microsystems, Inc.). The excitation laser source had a wavelength at 785 nm and a power of 8 mW at the sample. A 50× objective lens was used with a spot size of 2.2 μm. The integration time was set to be 2 minutes, and the wave-number range was from 504 cm⁻¹ to 1,076 cm⁻¹.

There are three signals of adenine molecules shown in FIG. 17. As the reference, graph A showed the Raman signal from a solution of 22 mM adenine on a glass surface without any nanoparticles. It was diluted in a blend of ethanol and DI water. The concentration of ethanol was 10.4 M. Both the adenine and ethanol peaks were shown in the Raman spectrum. The intensity of the signal with arbitrary units showed the fingerprint peak at 735 cm⁻¹ for adenine. Graph B showed the signal from a solution of 3.33 μM adenine using a conventional colloidal gold SERS technique. The sample was prepared by blending with 0.5 M sodium chloride, which is an activation agent to make the gold nanoparticles aggregate. After the mixing process, it took 15 minutes for gold nanoparticles to aggregate into clusters. Graph C showed the Raman signal from 3.33 μM adenine with the use of a nano-fluidic trapping device. The SERS signal was detected immediately after the sample was dispensed into the channel by capillary force. As depicted, the SERS signal from the optofluidic device is the highest of the three SERS approaches. Using graph A as the reference and the general calculation method, the enhancement factor of the SERS clusters created in the nano-fluidic trapping device was calculated to be 10⁸. From graph B and using the same calculation method, the enhancement factor of the conventional method was 10⁶.

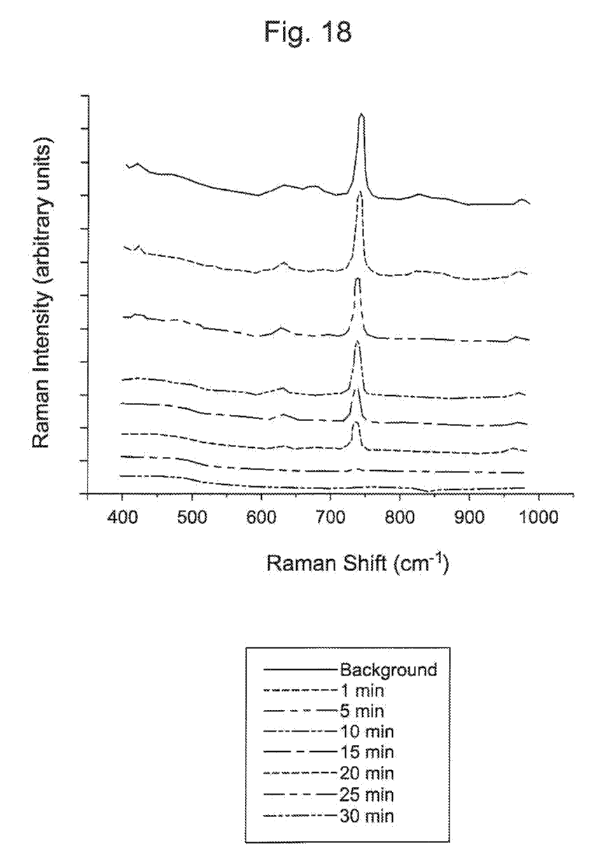

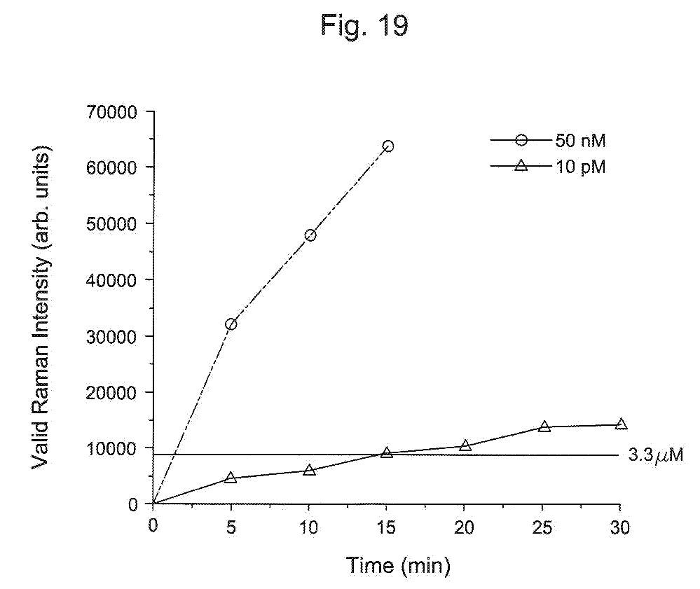

To demonstrate the molecular and nanoparticle enrichment effect, we monitored the SERS signal of adenine over time. The trapping effect of gold colloids and molecules may be stably maintained within 30 minutes after loading the sample solution into the reservoir. SERS signals of adenine molecules were measurable with a high signal to noise ratio to a concentration as low as 10 pM. The laser with a spot size of 2.2 μm was focused at the entrance of the nanochannel. The integration time of the Raman system was set to 1 minute throughout these experiments. The formation of gold clusters with a dimension of more than 10 μm was observed after sample solution dispersion. FIG. 18 showed the enhanced Raman signal from a 10 μM adenine solution monitored over 30 minutes after loading the sample solution into the reservoir. Capillary force transported gold nanoparticles and adenine molecules into the nanochannel entrance. FIG. 19 showed how the SERS signal intensity of adenine changed over time. Two adenine samples at different concentrations, 50 nM and 10 pM, were investigated. The signal from the 50 nM adenine sample increased and was saturated after 15 minutes. The SERS signal intensity of a 3.3 μM adenine concentration, immediately after loading the adenine solution into the device, is shown as the solid curve in the graph. As depicted, the signal from 10 pM adenine surpassed that of 3.3 μM adenine after 15 minutes. From this result, it can be concluded that the enrichment of gold nanoparticles and adenine near the entrance of the nanochannel was increased over time.

After 25 minutes, there was no obvious increase in the concentration because the fluidic flow was terminated. By comparing the final SERS signal intensity of 10 pM adenine to the reference line of 3.3 μM adenine, it can be concluded that a more than 10⁵ fold increase due to enriched nanoparticle-molecule concentration was accomplished by this nano-fluidic trapping device. The SERS enhancement reproducibility device to device for adenine with 83 nM was ±10%. This result was due to the inconsistency of the capillary flow.

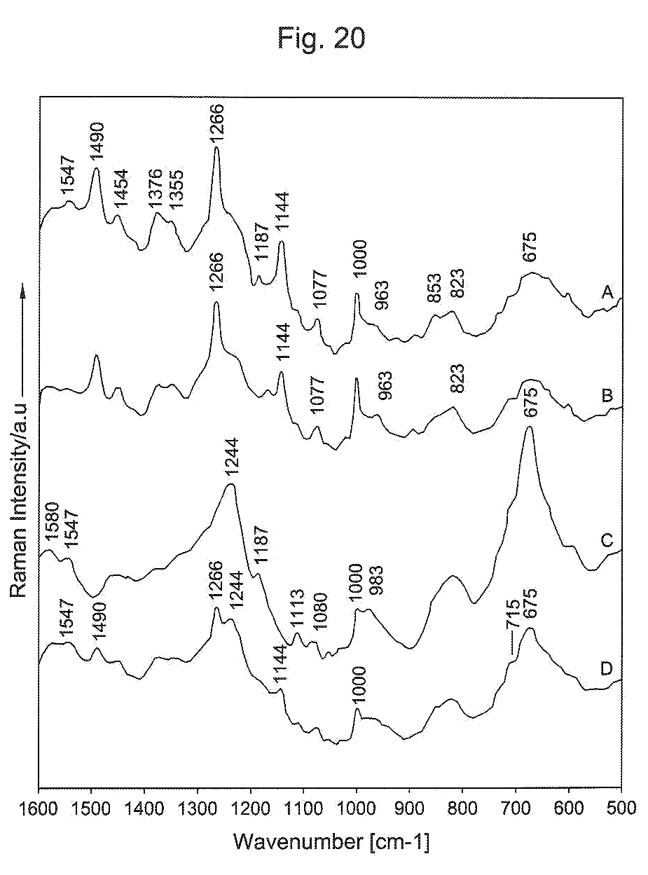

To confirm that the shifts in the SERS spectral modes may be observed due to conformational changes rather than the sole effect of changes in concentration, we performed SERS on beta-amyloid (Aβ) as a soluble monomer (as shown by references A and B on FIG. 20) and as an oligomer or other aggregated species (as shown by references C and D on FIG. 20). References A and B of FIG. 20 illustrate the SERS spectra of soluble Aβ taken after residing in the nanofluidic device at 6° C. for 38 and 48 hours, respectively. It has been shown that maintaining Aβ at low temperatures prevents or significantly retards aggregation. An increase in intensity over time of the SERS bands (except the band 1,000 cm⁻¹) in A and B of FIG. 20 was attributed to an increase in concentration of the target molecules and in the density of the clusters due to the continuous flow of the device (as previously illustrated in FIG. 18). This sharpening feature may be due to a longer interaction time, allowing more Aβ to bind to the surface of the nanoparticle. Also, a sharp band at 1,266 cm⁻¹ was observed in A and B of FIG. 20 due to the α-helix structure adsorbing to the metal surface. These spectra also exhibited distinct bands assigned to phenylalanine (1,000 cm⁻¹), histidine (1,488 cm⁻¹) and the tyrosine doublet (823 and 856 cm⁻¹).

In C and D of FIG. 20, the spectra of Aβ oligomer, prepared by allowing Aβ to aggregate at room temperature, contained similar qualities that are in contrast to the soluble monomers of A and B of FIG. 20, such as a relatively strong band at 1,244 cm⁻¹ (D of FIG. 20) and 1,266 cm⁻¹ (C of FIG. 20). The shift in the amide bands, from a mode characteristic of α-helix to β-sheet signified conformational changes in the Aβ peptide typical of the transition from soluble monomer to protofibrils or fibrils upon incubation. A strong band at around 1,244 cm⁻¹ associated with O-sheet structure was observed. Furthermore, the presence of the amide III modes (1,244 and 1,266 cm⁻¹) in C of FIG. 20 confirmed that the Aβ was in the midst of Aβ fibrillogenesis.

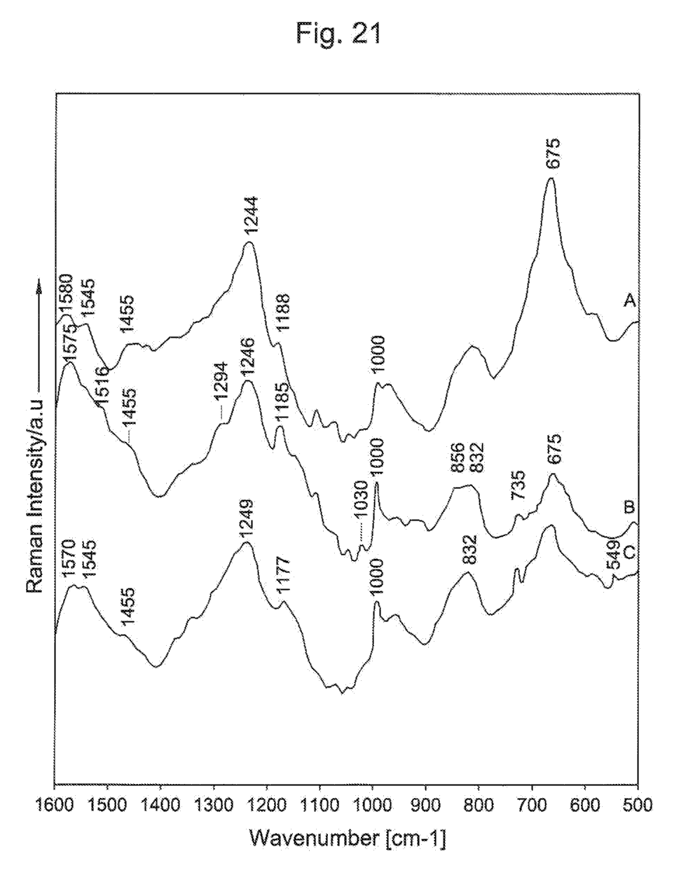

To test the feasibility of detecting Aβ in the presence of confounder proteins, SERS spectra of insulin and albumin were taken using the nanofluidic device and are shown in FIG. 21. A of FIG. 21 was the Aβ oligomer or aggregated species. The 675 cm⁻¹ band had a stronger intensity in the spectra of the insoluble Aβ oligomer than in the spectra of insulin (B of FIG. 21) and albumin (C of FIG. 21). Albumin (C of FIG. 21) is known to have a structure of around 55% α-helices and 45% random coil. The amide III band at 1,294 cm⁻¹, rather than at 1,244 cm⁻¹, may be due to modified Raman selection rules due to the α-helix not directly adsorbed to the metal surface because of the folding complexity of the protein. Albumin also showed strong bands associated with tyrosine, phenylalanine and tryptophan (832; 856; 1,000; 1,030; 1,185; and 1,580 cm⁻¹), indicating that albumin is adsorbed onto the nanoparticle surfaces via its aromatic side chains. Insulin (C of FIG. 21) consisted of two polypeptide chains joined with two cysteine disulfide bonds, with one disulfide bond involved in an intra-chain link. Although the C-S vibrations (654 cm⁻¹) are overlapped by the broad band at 675 cm⁻¹, the spectrum of insulin was distinguishable from the spectra of other proteins due to the S-S stretching mode at 549 cm⁻¹. A method of quantitatively assessing changes in a protein's structural conformation involved using a ratiometric measurement of the spectral height of amide III bands relative to some band (such as the CH₂ bending mode at 1,455 cm⁻¹) whose intensity was independent of conformational content. Taking ratiometric measurements of these bands gave ratios of 1.070, 1.223, 1.207, and 1.154 for Aβ monomer, Aβ oligomer, insulin, and albumin, respectively. The larger fraction indicated that more β-sheet and random coil structural elements were present in the protein. Consequently, we were able to distinguish confounder proteins from Aβ by their ratiometric spectral intensities and the absence and presence of certain Raman modes pertaining to amino acid residues in the protein available to interact with the metal surface.

Although the present invention and its advantages have been described in detail, it should be understood that various changes, substitutions and alterations may be made herein without departing from the spirit and scope of the invention as defined by the appended claims.

What is claimed is:

1. A nano-fluidic trapping device for assembling a SERS-active cluster, comprising:
a substrate;
a SERS-active cluster compartment, wherein the SERS-active cluster is formed in the SERS-active cluster compartment;
a reservoir, wherein the reservoir allows introduction of target molecules into the nano-fluidic trapping device;
a microchannel, wherein the microchannel allows the target molecules to be introduced to the SERS-active cluster compartment from the reservoir;
a nanochannel; and
wherein the SERS-active cluster compartment, the reservoir, the microchannel, and the nanochannel are disposed within the substrate.

2. The nano-fluidic trapping device of claim 1, wherein the substrate comprises fused silica.

3. The nano-fluidic trapping device of claim 1, wherein the SERS-active cluster compartment is disposed between the microchannel and the nanochannel, and wherein the SERS-active cluster compartment has a sloped side that slopes at an angle from the microchannel toward the nanochannel to reduce SERS-active cluster compartment volume as the sloped side approaches the nanochannel.

4. The nano-fluidic trapping device of claim 1, wherein the SERS-active cluster is formed in the SERS-active cluster compartment proximate to the nanochannel.

5. The nano-fluidic trapping device of claim 1, wherein the SERS-active cluster compartment has a SERS-active cluster compartment exit comprising a diameter smaller than a diameter of the SERS-active cluster.

6. The nano-fluidic trapping device of claim 1, wherein the microchannel has a width from about 15 μm to about 150 μm.

7. The nano-fluidic trapping device of claim 1, wherein the nanochannel has a depth from about 40 nm to about 50 nm.

8. The nano-fluidic trapping device of claim 1, wherein the SERS-active cluster compartment is disposed between the microchannel and the nanochannel, and wherein an entrance to the SERS-active cluster compartment has a diameter less than a diameter of the microchannel, and further wherein the SERS-active cluster compartment has a substantially uniform diameter from the entrance to a SERS-active cluster compartment exit.

9. The nano-fluidic trapping device of claim 1, wherein the SERS-active cluster compartment has a triangular configuration.

10. The nano-fluidic trapping device of claim 9, wherein the SERS-active cluster compartment is coated with a coating.

11. The nano-fluidic trapping device of claim 10, wherein the coating and metal nanoparticles form the SERS-active cluster with the target molecules.

12. The nano-fluidic trapping device of claim 1, wherein the SERS-active cluster compartment comprises a plurality of pillars.

13. The nano-fluidic trapping device of claim 12, wherein the pillars are coated with a coating.

14. The nano-fluidic trapping device of claim 13, wherein the coating and metal nanoparticles form the SERS-active cluster with the target molecules.

15. The nano-fluidic trapping device of claim 1, wherein metal nanoparticles and the target molecules form the SERS-active cluster.

16. The nano-fluidic trapping device of claim 15, wherein the metal nanoparticles are functionalized to provide specific binding of the target molecules.

17. The nano-fluidic trapping device of claim 1, wherein the target molecules are forced into the SERS-active cluster compartment from the microchannel by capillary force, an electro-osmotic pump, a centrifugal force, an electromagnetic field, or combination thereof.

18. A method of fabricating a nano-fluidic trapping device for forming a SERS-active cluster, comprising:
(A) providing a wafer;
(B) defining a microchannel, a nanochannel, and a SERS-active cluster compartment in the wafer to provide a defined wafer; and
(C) bonding the defined wafer with another wafer to form the nano-fluidic trapping device.

19. The method of claim 18, wherein defining is accomplished by photolithography or focused ion beam lithography.

20. The method of claim 18, wherein defining is accomplished by wet etching or plasma etching.
